(19) United States
(12) Patent Application Publication
(10) Pub. No.: US 2024/0040602 A1
(43) Pub. Date: Feb. 1, 2024

(54) Methods and Systems for Communication Optimization

(71) Applicant: COMCAST CABLE COMMUNICATIONS, LLC, Philadelphia, PA (US)

(72) Inventors: Yonatan Vaizman, Philadelphia, PA (US); Hongcheng Wang, Philadelphia, PA (US); Rama Mahajanam, Philadelphia, PA (US); Tianwen Chen, Philadelphia, PA (US)

(21) Appl. No.: 17/876,290

(22) Filed: Jul. 28, 2022

(51) Int. Cl. H04W 72/08; H04W 72/04

(52) U.S. Cl. CPC H04W 72/082; H04W 72/0453

(57) ABSTRACT

Methods, apparatuses, and systems are described for allocating a plurality of frequencies for use by a plurality of network devices. Measurement data associated with the plurality of network devices may be used to determine interference data. The interference data may be used to determine an allocation of the plurality of frequencies for use by the plurality of network devices.

### BACKGROUND

In dense areas, such as crowded city blocks with multiple apartments, there are typically multiple residences that each have its own Wi-Fi access point (AP). Wi-Fi communication uses radio channels for providing communication. Based on current Wi-Fi protocol, any device, such as an AP or client device, needs to wait until the radio channel is available before sending a packet. In these dense areas, devices in one home can sense the Wi-Fi signals from many devices in neighboring homes, which may act as interference for that home. Thus, in these dense areas, one home's Wi-Fi network needs to share airtime with the neighboring homes that use the same radio channel. This causes a decrease in the quality of service of a home's internet experience resulting in such issues as an increased latency in loading web pages and buffering video streams. Allocating the radio channels of the Wi-Fi APs in the dense areas in an efficient manner may provide a means for reducing the interference caused by neighboring Wi-Fi APs and increase the quality of service for each home's internet experience.

### SUMMARY

It is to be understood that both the following general description and the following detailed description are examples and explanatory only and are not restrictive. Methods, systems, and apparatuses for interference management are disclosed.

A frequency allocation configuration associated with multiple network devices may be determined. The network devices may be in a dense area (e.g., many network devices), such as an apartment building. Interference data may be generated based on signal measurements associated with each AP within a predetermined area. The interference data may be used to cause one or more of the APs to use a specified frequency.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for maintaining an allocation of frequencies for use by the network devices;

FIG. 2A shows an example scenario for allocating frequencies for use by the network devices;

FIG. 2B shows another example scenario for allocating frequencies for use by the network devices;

FIG. 2C shows another example scenario for allocating frequencies for use by the network devices;

FIG. 3 shows an example method for determining the frequency allocation;

FIG. 4 shows an example interference matrix optimization;

FIG. 5 shows a flowchart of an example method for allocating frequencies for use by the network devices;

FIG. 6 shows a flowchart of another example method for allocating frequencies for use by the network devices;

FIG. 7 shows a flowchart of another example method for allocating frequencies for use by the network devices; and

FIG. 8 shows a block diagram of an example system and computing device for receiving measurement data and determining the allocation of the frequencies for use by the network devices.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

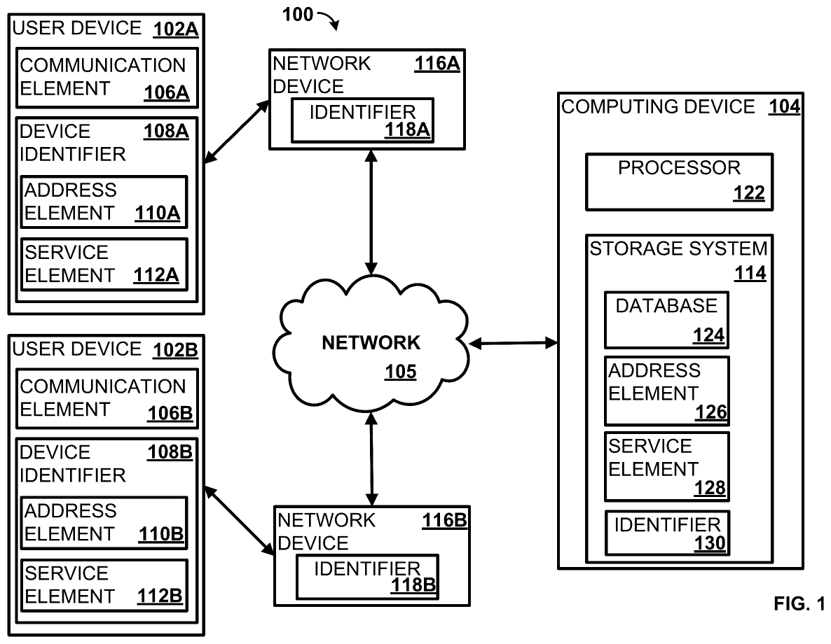

FIG. 1 shows an example system 100 for allocating frequencies (e.g., channels) for use by network devices. For example, the system 100 may be configured to receive measurement data associated with a plurality of radio signals used by a plurality of network devices. The measurement data may be used to determine interference data (e.g., interference matrix). The interference data may be used to determine an allocation of frequencies for use by each network device. A computing device may use the interference data to cause each network device to use an assigned frequency. The system 100 may comprise a plurality of user devices 102A-102B in communication with a plurality of network devices 116A-116B, such as a plurality of AP devices, for example. The user devices 102A-102B may use one or more radio frequencies for accessing network services (e.g., a network 105) via the network devices 116A-116B. The network devices 116A-116B may be disposed in several dwellings, such as several apartment units in an apartment building. The network devices 116A-116B may facilitate access to the network 105 for one or more user devices 102A-102B. The network devices 116A-116B may be in communication with a computing device 104 such as a centralized device or a server, for example. The computing device 104 may be disposed remotely relative to the user devices 102A-102B and the network devices 116A-116B. As an example, the network devices 116A-116B and the computing device 104 may be in communication via a private and/or public network 105 such as the Internet or a local area network. Other forms of communications can be used such as wired and wireless telecommunication channels.

The user devices 102A-102B may comprise electronic devices such as a computer, a smartphone, a laptop, a tablet, a set top box, a display device, a printer, a telephone, a cordless phone, a network node, a network device, a communication terminal, a transmitter, or other device capable of communicating with the network devices 116A-116B. As an example, the user devices 102A-102B may comprise communication elements 106A-106B for offering an interface to a user to interact with the user devices 102A-102B and/or the computing device 104. The communication element 106A-106B can be any interface for presenting and/or receiving information to/from the user, such as media content. An example interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the user devices 102A-102B and the network devices 116A-116B. As an example, the communication elements 106A-106B can request or query various files from a local source and/or a remote source. As a further example, the communication element 106A-106B can transmit data to a local or remote device such as the network devices 116A-116B or the computing device 104 via the network devices 116A-116B.

The user devices 102A-102B may be associated with user identifiers or device identifiers 108A-108B. As an example, the device identifiers 108A-108B may be any identifier, token, character, string, or the like, for differentiating one user or user device (e.g., a user device 102A) from another user or user device. The device identifier 108A-108B can identify a user or user device as belonging to a particular class of users or user devices. As a further example, the device identifier 108A-108B may comprise information relating to the user device such as a manufacturer, a model or type of device, a service provider associated with the user device 102A-102B, a state of the user device 102A-102B, a locator, and/or a label or classifier. Other information can be represented by the device identifiers 108A-108B.

The device identifiers 108A-108B can comprise address elements 110A-110B and service elements 112A-112B. The address elements 110A-110B may comprise or make available an internet protocol address, a network address, a media access control (MAC) address, an Internet address, or the like. As an example, the address elements 110A-110B may be relied upon to establish a communication session between the user devices 102A-102B and the network devices 116A-116B or other devices and/or networks. As a further example, the address elements 110A-110B may be used as an identifier or locator of the user devices 102A-102B. The address elements 110A-110B may be persistent for a particular network.

The service elements 112A-112B may comprise identification of the service providers associated with the user devices 102A-102B and/or with the class of user devices 102A-102B. The class of the user devices 102A-102B may be related to a type of device, a capability of a device, a type of service being offered, and/or a level of service (e.g., a business class, a service tier, a service package, etc.). As an example, the service elements 112A-112B may comprise information relating to or made available by a communication service provider (e.g., an Internet service provider) that is offering or enabling data flow such as communication services to the user devices 102A-102B. As a further example, the service elements 112A-112B may comprise information relating to a preferred service provider for one or more particular services relating to the user devices 102A-102B. The address elements 110A-110B may be used to identify or retrieve data from the service elements 112A-112B, or vice-versa. As a further example, one or more of the address elements 110A-110B and the service elements 112A-112B can be stored remotely from the user devices 102A-102B and retrieved by one or more devices such as the user devices 102A-102B and the computing device 104. Other information can be represented by the service element 112A-112B.

A plurality of network devices 116A-116B may be in communication with a network, such as network 105. As an example, one or more of the network devices 116A-116B may be configured to facilitate the connection of a device, such as the user device 102A-102B, to the network 105. As a further example, the network devices 116A-116B may be configured as wireless access points (WAPs). The network devices 116A-116B may be configured to allow one or more wireless devices to connect to a wired and/or wireless network using Wi-Fi, Bluetooth®, Zigbee®, or any desired method or standard.

The network devices 116A-116B may be configured as a local area network (LAN). As an example, the network devices 116A-116B may comprise a dual band wireless access point. As an example, the network devices 116A-116 may be configured with a first service set identifier (SSID) (e.g., associated with a user network or a private network) to function as a local network for a particular user or users. As a further example, the network devices 116A-116 may be configured with a second service set identifier (SSID) (e.g., associated with a public/community network or a hidden network) to function as a secondary network or redundant network for connected communication devices.

The network devices 116A-116B may comprise identifiers 118A-118B. As an example, one or more identifiers can be or relate to an Internet Protocol (IP) Address IPV4/IPV6 or a media access control address (MAC address) or the like. As a further example, the identifiers 118A-118B may be unique identifiers for facilitating communications on the physical network segment. Each of the network devices 116A-116B may comprise an identifier 118 that is distinct. As an example, the identifiers 118A-118B may be associated with a physical location of the network devices 116A-116B.

Each device (e.g., the user devices 102A-102B or the network devices 116A-116B) may be configured to receive measurement data from one or more sources, such as from one or more user devices 102A-102B, one or more network devices 116A-116B, or one or more sensors configured to monitor and gather the measurement data associated with the radio signals of each network device 116A-116B. For example, the measurement data may comprise one or more of a percentage of time each network device 116A-116B uses each frequency of a plurality of frequencies, information indicative of each time period of a plurality of time periods each network device 116A-116B uses each frequency, an amount of time each network device 116A-116B uses each frequency, a signal strength associated with each radio signal of each network device 116A-116B, or information indicative of each network device 116A-116B that can detect a radio signal of another network device 116A-116B, and the like. The devices may be configured to receive the measurement data at predetermined time intervals and/or over a predetermined period of time. The devices may receive the measurement data through wireless links (e.g., a radio frequency, a satellite) and/or physical links (e.g., a fiber optic cable, a coaxial cable, an Ethernet cable, or a combination thereof). The devices may be configured to send the measurement data to the computing device 104 for further processing.

The computing device 104 may be a server, or a centralized device, for communicating with the network devices 116A-116B, or the user devices 102A-102B via the network devices 116A-116B. In an example, the computing device 104 may communicate with the user devices 102A-102B for offering data and/or services. For example, the computing device 104 may offer services such as network (e.g., Internet) connectivity, network printing, media management (e.g., a media server), interference management, content services, streaming services, broadband services, or other network-related services. The computing device 104 may be configured to generate interference data (e.g., pain, or interference, matrix) where given a number of apartment units and frequencies, the computing device 104 may determine an optimal allocation of frequencies to be used by the network devices 116A-116B. For example, the computing device 104 may be configured to receive measurement data associated with a plurality of radio signals used by the network devices 116A-116B and determine interference data (e.g., pain, or interference, matrix) based on the measurement data. The computing device 104 may the use the interference data to determine an allocation of frequencies for use by the network devices 116A-116B.

The computing device 104 may allow the user devices 102A-102B to interact with remote resources such as data, devices, and files. As an example, the computing device 104 may be configured as (or disposed at) a central location (e.g., a headend, or a processing facility), which can receive content (e.g., data, input programming) from multiple sources. The computing device 104 may be a separate/remote device from the headend for providing the frequency allocation services associated with a predetermined area, such as the use of a single computing device 104 for a single apartment building, for example. The computing device 104 can combine the content from the multiple sources and can distribute the content to user (e.g., subscriber) locations via a distribution system.

The computing device 104 may be configured to manage the communication between the user devices 102A-102B and a storage system 114 for sending and receiving data therebetween. As an example, the storage system 114 can store a plurality of files, user identifiers or records, or other information. As a further example, the user devices 102A-102B may request and/or retrieve one or more files from the storage system 114. The storage system 114 can store information relating to the user devices 102A-102B such as the address elements 110A-110B and/or the service elements 112A-112B. As an example, the computing device 104 may obtain the device identifiers 108A-108B from the user devices 102A-102B and retrieve information from the storage system 114 such as the address elements 110A-110B and/or the service elements 112A-112B. As a further example, the computing device 104 may obtain the address elements 110A-110B from the user devices 102A-102B and may retrieve the service elements 112A-112B from the storage system 114, or vice versa. The storage system 114 may comprise a database 124 configured for storing measurement data (e.g., interference data) received from the plurality of interference sources (e.g., network devices 116A-116B), storing interference patterns based on the interference data, storing interference signatures, and/or storing interference maps. For example, database 124 may store measurement data associated with a plurality of radio signals used by the plurality of network devices 116A-116B and/or the signal strengths associated with the radio signals of the plurality of network devices 116A-116B. The computing device 104 may search the database 124 to determine measurement data comprising one or more of a percentage of time each network device 116A-116B uses each frequency of the plurality of frequencies, information indicative of each time period of a plurality of time periods each network device 116A-116B uses each frequency, an amount of time each network device 116A-116B uses each frequency, a signal strength associated with a radio signal of each network device 116A-116B, or information indicative of each network device 116A-116B that can detect a radio signal of another network device 116A-116B. Any information can be stored in and retrieved from the storage system 114. The storage system 114 can be disposed remotely from the computing device 104 and accessed via direct or indirect connection. The storage system 114 can be integrated with the computing device 104 or some other device or system.

The computing device 104 may be configured to receive the measurement data from one or more sources, such as from one or more user devices 102A-102B, one or more network devices 116A-116B, or one or more sensors configured to monitor and gather the measurement data associated with the radio signals of each network device 116A-116B. For example, the measurement data may comprise one or more of a percentage of time each network device 116A-116B uses each frequency of a plurality of frequencies, information indicative of each time period of a plurality of time periods each network device 116A-116B uses each frequency, an amount of time each network device 116A-116B uses each frequency, a signal strength associated with each radio signal of each network device 116A-116B, or information indicative of each network device 116A-116B that can detect a radio signal of another network device 116A-116B, and the like. The computing device 104 may be configured to receive the measurement data at predetermined time intervals and/or over a predetermined period of time. The computing device 104 may receive the measurement data through wireless links (e.g., a radio frequency, a satellite) and/or physical links (e.g., a fiber optic cable, a coaxial cable, an Ethernet cable, or a combination thereof).

The computing device 104 may comprise a processor 122. The processor 122 may determine (e.g., calculate, create, generate) interference data (e.g., pain, or interference, matrix) based on the measurement data. The interference data may be indicative of AP utilization information and AP scan information. The AP utilization information may comprise a percentage of time each frequency of the plurality of frequencies is used by each network device 116A-116B of the plurality of network devices 116A-116B, and the AP scan information may comprise information indicative of each network device 116A-116B that can detect a radio signal of another network device 116A-116B of the plurality of network devices 116A-116B. The interference data may be further indicative of interferences caused by a network device 116A-116B detecting a radio signal of another network device 116A-116B and the percentage of time each network device 116A-116B uses the internet during at least one time period of a plurality of time periods. The computing device 104 may allocate the usage of the radio frequencies by each of the network devices 116A-116B based on the interference data. For example, the computing device may cause each network device 116A-116B to use an assigned frequency based on a comparison of a percentage of time each frequency of the plurality of frequencies used by each network device 116A-116B and information indicative of each network device 116A-116B that can detect a radio signal of another network device 116A-116B. The computing device 104 may be configured to cause at least two network devices 116A-116B to use the same frequency based on determining that the two network devices 116A-116B cannot detect each other's radio signal. The computing device 104 may be configured to cause each network device 116A-116B of the plurality of network devices 116A-116B to use the same frequency based on determining that a network device 116A-116B uses its frequency, or uses the internet a relatively high percentage of time, during a different time period than another network device 116A-116B regardless of whether both network devices 116A-116B may be able to detect each other's radio signals. The computing device 104 may cause two network devices 116A-116B to use different frequencies based on determining that they can detect each other's signals and that they tend to use a high amount of internet during similar time periods.

The measurement data may comprise location information (e.g., spatial coordinates) of a plurality of network devices (e.g., the network devices 116A-116B). The measurement data may be stored in the database 124. An interference pattern may be determined based on the measurement data. The interference data may be indicative of the interference pattern. The interference pattern can be plotted on an interference map.

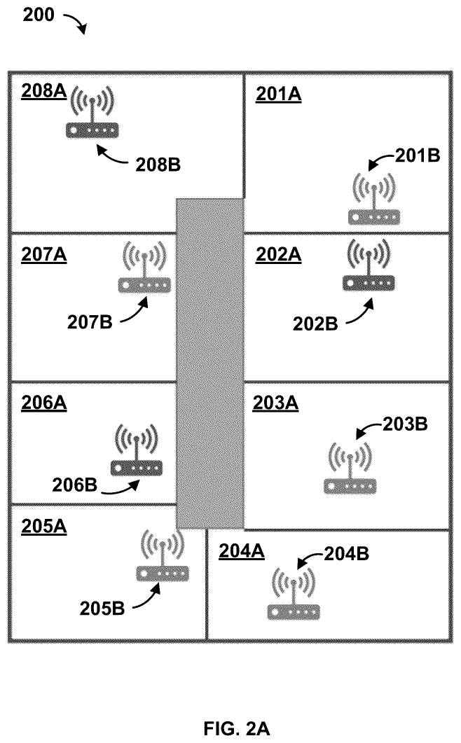

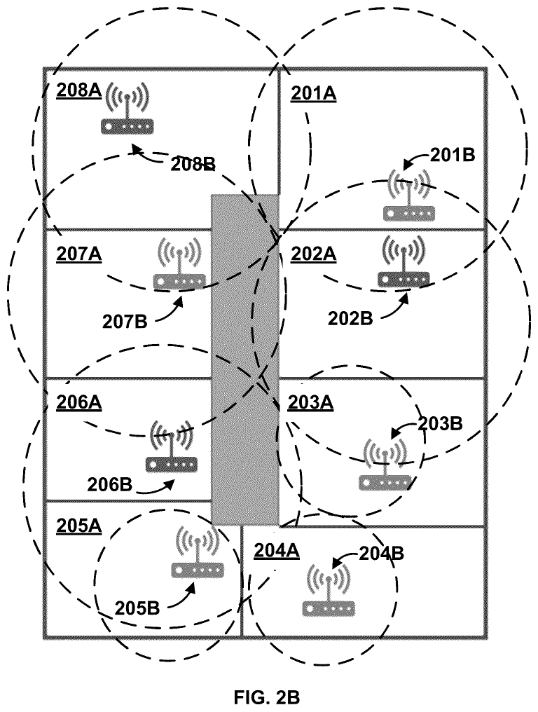

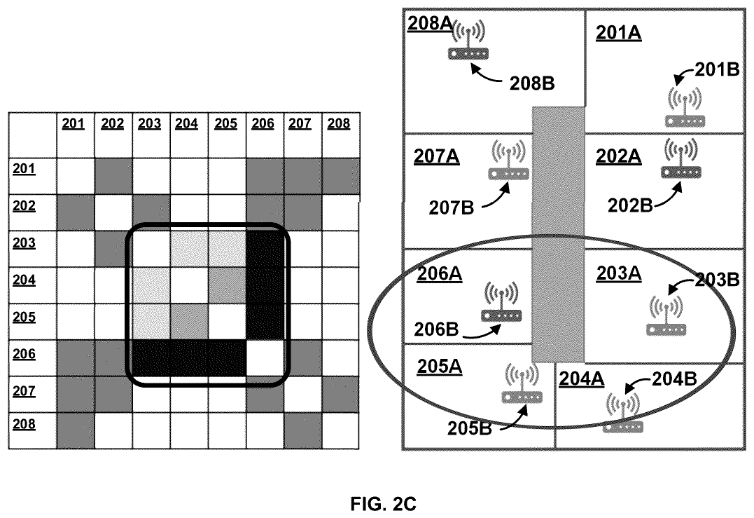

FIG. 2A shows an example layout of a floor of an apartment building with several network devices (e.g., a wireless access points (APs)) in several apartment units. FIG. 2A shows apartments 201A-208A each having at least one network device 201B-208B (e.g., a wireless access point (AP)). In dense areas, such as the apartment building, as shown in FIG. 2A, wherein there are several network devices (e.g., wireless APs) using radio signals, the network devices (e.g., wireless APs) may create a certain amount of inference for another network device (e.g., wireless AP) that can detect the radio signal being used by adjacent network devices (e.g., wireless APs). The amount of interference that one network device (e.g., wireless AP) senses from neighboring network devices (e.g., wireless APs) depends on several aspects such as physical proximity, the layout of the walls, doors and windows, and the materials (glass, concrete, wood, etc.) of the apartment building. A computing device, one or more user devices, and/or one or more network devices may receive measurement data associated with the radio signals used by the plurality of network devices (e.g., wireless APs). The measurement data may include one or more of a percentage of time each network device (e.g., wireless AP) uses each frequency of a plurality of frequencies, information indicative of each time period of a plurality of time periods each network device (e.g., wireless AP) uses each frequency, an amount of time each network device (e.g., wireless AP) uses each frequency, a signal strength associated with a radio signal of each network device (e.g., wireless AP), or information indicative of each network device (e.g., wireless AP) that can detect a radio signal of another network device. FIG. 2B shows an example of the apartment units' network devices (e.g., wireless APs) and their projected radio signals. In the example scenario, in FIG. 2B, network devices 201B, 203B, 204B, 205B, and 207B are each using the same frequency and network devices 202B, 206B, and 208B are each using the same frequency. For example, it may be determined that: network device 201B can only detect the radio signals of network devices 202B and 208B; network device 202B can only detect the radio signals of network devices 201B, 203B, and 207B; network device 203B can only detect the radio signals of network devices 202B and 205B; network devices 204B and 205B can only detect the radio signals of network device 206B; network device 206B can only detect the radio signals of network devices 203B, 204B, 205B, and 207B; network device 207B can only detect the radio signals of network devices 202B, 206B, and 208B; and network device 208B can only detect the radio signals of network devices 201B and 207B. Frequencies (e.g., channels) may be assigned for use by the network devices (e.g., wireless APs) accordingly, for example, by a computing device and/or one or more of the network devices 201B-208B. Network devices 203B, 204B, and 205B may be able to detect each other. However, because the network devices (e.g., wireless APs) use the Internet at different time periods of the day, the network devices (e.g., wireless APs) may be assigned the same frequency according to those different time periods.

FIG. 2C shows an example of assigning frequencies (e.g., channels) for use by a plurality of network devices (e.g., wireless APs) based on measurement data. The measurement data may be used to determine interference matrix (e.g., interference data), as shown in FIG. 2C. For example, the interference matrix may be indicative of whether an apartment's network device (e.g., wireless AP) can detect signals from another apartment's network device (e.g., wireless AP) and of an “amount” of interference based on that detection. For example, the “amount” of interference may be based on one or more of a percentage of time each network device (e.g., wireless AP) uses each frequency of the plurality of frequencies, each time period of a plurality of time periods each network device (e.g., wireless AP) uses each frequency, an amount of time each network device (e.g., wireless AP) uses each frequency, a signal strength associated a radio signal of each network device (e.g., wireless AP), or information indicative of each network device (e.g., wireless AP) that can detect a radio signal of another network device (e.g., wireless AP). In an example, the matrix items shown in relation to network devices 203B, 204B, 205B, and 206B may be completely black indicating that each network device (e.g., wireless AP) may detect each other's signals and that the devices use the internet a relatively high percentage of time during similar time periods. A computing device may assign the radio frequencies for use by each network device (e.g., wireless AP) based on the received measurement data. FIG. 2C shows that, based on the measurement data, the network devices 201B, 203B, 204B, 205B, and 207B may be assigned the same frequency while the network devices 202B, 206B, and 208B may be assigned another frequency in order to reduce any interference that may be caused by adjacent network devices (e.g., wireless APs) using relatively high amounts of internet during the same periods of time. Network devices 203B, 204B, and 205B may be able to detect each other. For example, as shown in FIG. 2C, these pairs of network devices (e.g., wireless APs) are associated with shades of gray colors, shown in the interference matrix, indicating that these apartments can detect, or sense, each other. Because these network devices (e.g., wireless APs) use the internet at different time periods of the day, they have a small potential to interfere with each other, which is indicated by the light gray colors in the interference matrix, unlike the dark black colors for other network device (e.g., wireless AP) pairs indicating a high potential of interference for those network device (e.g., wireless AP) pairs.

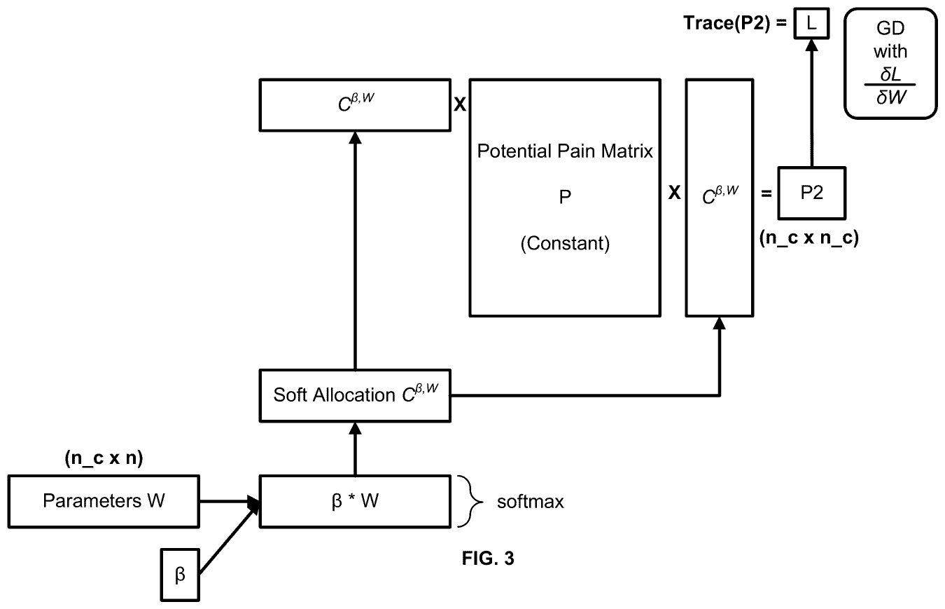

FIG. 3 shows an example involving the use of the Gradient Descent method, or algorithm, for determining the allocation of the frequencies (e.g., channels) to be used by the plurality of network devices. The algorithm may be applied to the whole group of network devices (e.g., all of the network devices from a building, block, geohash area, etc.) without clustering into smaller sub-groups. The method may be based on building a network (e.g., neural network, but with less traditional functions), as shown in FIG. 3. The network may start with a single “dummy” scalar input. The network's parameters may involve a matrix of real values, representing for each network device its “tendency” towards each of the optional frequencies. The network multiplies the parameter matrix by the dummy scalar input to scale these “tendencies” and then applies a softmax operation on each network device's row to turn it into a valid probability distribution. This determines the soft-allocation of each network device to the optional frequencies (as a probability distribution over the frequencies). The network then uses the provided estimated potential-pain matrices P (and Q, if needed) and calculates an approximate total-pain value for the entire building/block. This involves a calculation that is quadratic in the soft-frequency-allocations C soft, but linear in the provided potential-pain matrices P and Q. This is an approximate because the soft-allocations allow a network device to be “partly allocated” to different frequencies. By tuning the input parameter, the approximations of an actual setting where each network device is allocated exactly a single frequency may be controlled. The model's parameters are initialized randomly (causing the initial soft frequency allocations to be random, resulting in a “not-so-good” total pain in the initial state). Using Gradient Descent, the model iteratively updates the parameters to reduce the total pain, until it converges to a local minimum. The converged solution determines which frequency each network device should use, and the converged total pain should be a local optimum interference level for the group of network devices.

The start of the updating procedure may start with a low value for the dummy input scalar (e.g. 1), which tends to generate soft-allocations that are closer to a uniform distribution over the optional frequencies. This allows the algorithm to start with a rough approximation of total pain and help it look for good global areas in the parameter space. In later update steps, the algorithm may use a higher value of the input scalar (e.g. 100), which tends to generate soft-allocations that are closer to a valid frequency-allocation (for each network device, only a single frequency will get a probability close to 1). This will allow the network to better approximate the total pain, and fine tune the parameters to a better local minimum. The frequency allocation may be optimized based on finding the frequency allocation C that minimizes the total interference (e.g., pain). The formula for the total interference may include a sum over network devices (over homes in the building/block). The interference may be minimized by minimizing the average-case home's pain.

The model may be adjusted to include the “worse-home-pain.” In addition to the quadratic term of the soft-frequency-allocation, the individual pain that each network device suffers may be added to the calculation and the maximum function with a soft version may be approximated (again, a parameter may be used to tune how closely this approximates max pain). Subsequently, the output of the model may be the weighted sum of the total pain and the approximate-max pain.

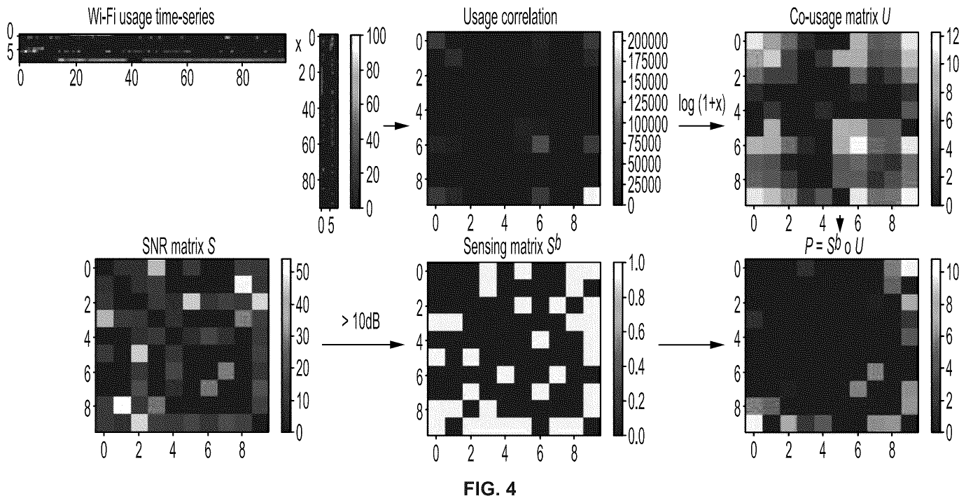

The interference matrix represents the “potential pain” matrix P (and Q, if needed). Q represents (for each network device and each frequency) what would be the added external-source of pain if the network device was using that frequency. P represents (for each pair of network devices) what would be the added pain that each network device caused the other network devices, if both devices use the same frequency. In order to determine the appropriate frequency allocation, the “potential pain” matrix P is estimated/calculated. The “potential pain” matrix P may then be used as a constant for the optimization problem. P is a square matrix that represents for each pair of network devices what would be the added pain if both network devices were on the same frequency. After solving the optimization (frequency-allocation) problem, only a subset of P's entries will influence the total pain. However, to solve the problem, the full matrix needs to be calculated by determining what would be the pain for each pair of network devices if they were on the same frequency, in order to decide which pairs should be on the same frequency. To calculate each entry <i,j> in matrix P, two components must be determined: “can network device i sense network device j?” and “how likely are the two network devices to use a lot of internet at the same time?” As shown in FIG. 4, “co-usage” matrix U may be determined based on the “severity” of any two network devices of the group using internet at the same time. Separately, a mask matrix S (e.g., the “sensing matrix”), as shown in FIG. 4, may be calculated from the scan data with zeros in the entries of the network device-pairs that cannot see each other. The scan data may include data indicative of the other network devices a network device can sense in each frequency band and the associated signal strengths. Matrix S can have real non-negative values, wherein the non-zero elements represent the signal to noise ratio (SNR) of how strongly network device i senses network device j. Alternatively, S can be a binary-valued matrix, wherein the non-zero elements have a value of 1 to indicate that network device i senses network device j strongly enough. Lastly, as shown in FIG. 4, the two matrices may be multiplied, elementwise, to get matrix P (P=U*S) resulting in a sparse matrix wherein many entries will have zero (because the two network devices are too far to sense each other so they'll have zero potential to cause pain to each other), and the rest of the entries will have a range of potential-pain values, depending on how much and when do the network devices use the internet.

The co-usage matrix may be estimated using finer time-resolution measurements, such as in the example shown in FIG. 4. In one example, load and interference measurements may be received every fifteen minutes, wherein the measurements may be used as a time-series instead of reducing the load (or interference) of a network device to a single number. Based on these measurements, it may be determined that a network device has a very high load between 7-8 pm while its neighbor network device has very high load between 9-10 pm. Since neither network device use the frequency at the same time, they don't interfere with each other. Thus, the pain may be calculated for each time-point separately (e.g., every 15 minutes), and then aggregate over time (e.g., over 7-10 pm). In another example, measurements from a whole day may be utilized. Some homes may experience peak Wi-Fi usage/interference/pain at different times of the day, especially in work-from-home settings. Keeping the fine-resolution of the time-series of load of each network device, a dot product of two time-series (from two network devices) may be determined in order to capture the Wi-Fi pain they would cause each other (if they were on the same frequency) over a whole day. The dot product may be between the load time-series of the two network devices, or one (or both) of them can have adjusted values with non-linearity. In another example, measurement data from several days (not just the most recent day) may be used to assess the risk that two network devices have high uses of internet during the same time. The potential pain matrix P may be calculated using measurement data from several days instead of just one day. In another example, weights may be given to past observations. For example, measurement data from more recent days may be given higher weights. Alternatively, if optimizing for the next day, matrix U may be estimated from data from the most recent two weeks, giving higher weight to the measurement data from days that were the same weekday as the next day. This may be useful for analyzing internet-usage patterns that depend on the day of the week instead of the time of the day. For example, if optimizing frequencies for tomorrow, which is a Monday, measurements from the past two weeks may be used, where a higher weight is given to measurements from the recent two Mondays and lower weights to the recent two Sundays.

The sensing matrix S (who can sense whom) may be estimated using similar options. The most recent scan report from each network device may be used, or all of the scan reports from the most recent day, week, or month may be used. In an example scenario, if the environment in the building/block is fast changing (e.g., every day someone moves in or out, people change their home furniture setup or network device location, there's construction of a new building nearby, etc.), then the more recent scan data may be used to estimate matrix S.

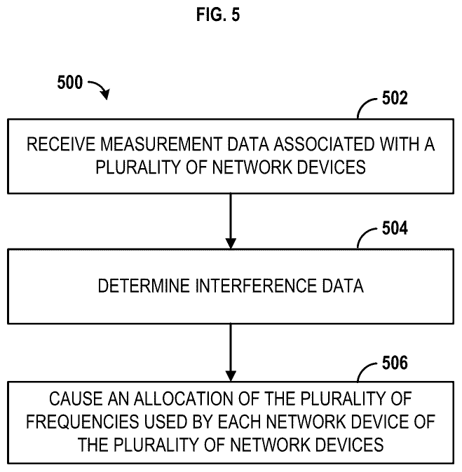

FIG. 5 shows a flowchart of an example method 500. Method 500 may be implemented, for example, by the computing device 104, one or more network devices 116A-116B, or any combination thereof. At step 502, measurement data associated with a plurality of network devices (e.g., AP devices) may be obtained. For example, the measurement data may comprise one or more of a percentage of time each network device uses each frequency of the plurality of frequencies, information indicative of each time period of a plurality of time periods each network device uses each frequency, an amount of time each network device uses each frequency, a signal strength associated with a radio signal of each network device, or information indicative of each network device that can detect a radio signal of another network device. The measurement data may be received at predetermined intervals and/or over a predetermined period of time. In one example, the measurement data may be received every 15 minutes over the course of one day. In another example, the measurement data may be received every 2 hours over the course of a few days.

At step 504, interference data may be determined based on the measurement data. The interference data may be associated with AP utilization information and AP scan information. The AP utilization information may comprise a percentage of time each frequency of the plurality of frequencies is used by each network device, and the AP scan information may comprise information indicative of each network device that can detect a radio signal of another network device of the plurality of network devices. The interference data may be indicative of interferences caused by a network device detecting a radio signal of another network device of the plurality of network devices and the percentage of time each network device uses the internet during at least one time period of a plurality of time periods.

At step 506, the plurality of frequencies used by each network device of the plurality of network devices may be allocated. For example, each network device may be caused to use an assigned frequency based on a comparison of a percentage of time each frequency of the plurality of frequencies is used by each network device and information indicative of each network device that can detect a radio signal of another network device of the plurality of network devices. A Gradient Descent algorithm may be used to determine the frequency allocation. One or more input parameters may be provided to a network (e.g., neural network), wherein a soft allocation of a plurality of frequencies used by the plurality of network devices may be determined using the input parameters. The network may use the determined interference data and the soft allocation of the plurality of frequencies to determine an interference value associated with the plurality of network devices. The determined interference value may be used to determine the allocation of the frequencies to be used by the plurality of network devices. The interference value is associated with the total pain caused by the allocation of frequencies used by the network devices. The input parameters for the network may be iteratively updated using the Gradient Descent algorithm until the interference value converges to a local minimum. The input parameters may be iteratively updated until the interference value converges on a value associated with the worst case scenario. The frequency allocation is optimized according to a “worse-home-pain.”

The current frequency that each network is using may be analyzed and a frequency allocation may be determined that requires fewer network devices to switch frequencies (while most of the network devices in the neighborhood may keep their current frequency). For example, if there are multiple frequency allocation configurations that would achieve a similar total pain (e.g., total interference), the algorithm may indicate a preferred configuration that is closer to the current allocation of frequencies used by the network devices, and thus, requiring fewer network devices to switch frequencies. The algorithm may use the Gradient Descent procedure multiple times, wherein each time the procedure is started with a new random initialization of the parameters. The algorithm may compare the total pain that each iteration calculates with a measure of the number of network devices that need to switch frequencies if the new frequency allocation is selected (e.g., number of network devices that would switch a frequency, or a percentage of network devices that would switch a frequency). The algorithm may use both of these numbers (e.g., with a linear combination of both) to select a preferred frequency allocation. The neural network may be provided with another component indicating the currently used frequency allocation in the building as an input, and then compute the change from that frequency allocation to the new frequency allocation that the network generates. The neural network can then calculate a new output that is a combination of the approximated total pain and the measure of change of the new frequency allocation compared to the currently-used frequency allocation. The Gradient Descent algorithm will then automatically try to find a solution (e.g., frequency allocation) that is better in both the total pain and requiring fewer frequency switches.

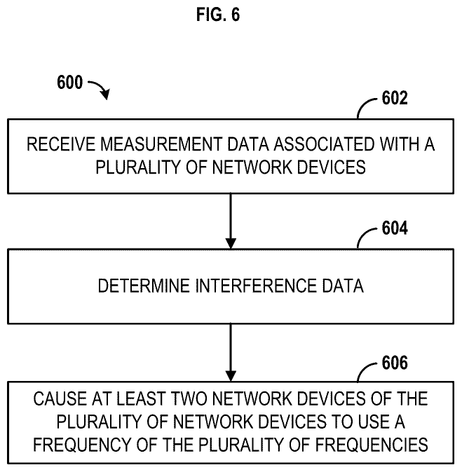

FIG. 6 shows a flowchart of an example method 600. Method 600 may be implemented, for example, by the computing device 104, one or more network devices 116A-116B, or any combination thereof. At step 602, measurement data associated with a plurality of network devices (e.g., AP devices) may be obtained. For example, the measurement data may comprise one or more of a percentage of time each network device uses each frequency of the plurality of frequencies, information indicative of each time period of a plurality of time periods each network device uses each frequency, an amount of time each network device uses each frequency, a signal strength associated with a radio signal of each network device, or information indicative of each network device that can detect a radio signal of another network device. The measurement data may be received at predetermined intervals and/or over a predetermined period of time. In one example, the measurement data may be received every 20 minutes over the course of one day. In another example, the measurement data may be received every 5 hours over the course of a week.

At step 604, an interference data may be determined based on the measurement data. The interference data may be associated with AP utilization information and AP scan information. The AP utilization information may comprise a percentage of time each frequency of the plurality of frequencies is used by each network device, and the AP scan information may comprise information indicative of each network device that cannot detect a radio signal of another network device of the plurality of network devices. The interference data is indicative of interferences caused by a network device detecting a radio signal of another network device of the plurality of network devices and the percentage of time each network device uses the internet during at least one time period of a plurality of time periods. At step 606, at least two network devices may be caused to use the same frequency based on a determination that the at least two network devices cannot detect each other's radio signal.

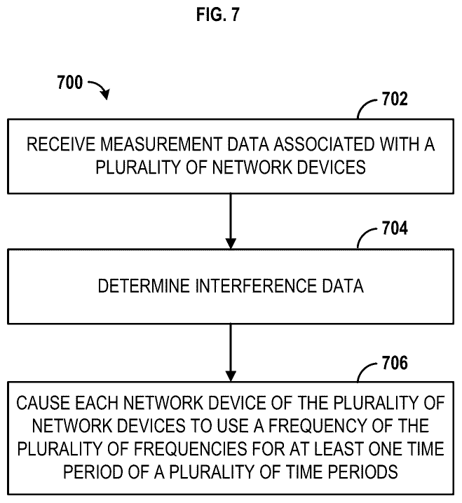

FIG. 7 shows a flowchart of an example method 700. Method 700 may be implemented, for example, by the computing device 104, one or more network devices 116A-116B, or any combination thereof. At step 702, measurement data associated with a plurality of network devices (e.g., AP devices) may be obtained. For example, the measurement data may comprise one or more of a percentage of time each network device uses each frequency of the plurality of frequencies, each time period of a plurality of time periods each network device uses each frequency, an amount of time each network device uses each frequency, a signal strength associated with a radio signal of each network device, or information indicative of each network device that can detect a radio signal of another network device. The measurement data may be received at predetermined intervals and/or over a predetermined period of time. In one example, the measurement data may be received every 5 minutes over the course of a few hours. In another example, the measurement data may be received every hour from the most recent day.

At step 704, an interference data may be determined based on the measurement data. The interference data may be associated with AP utilization information and AP scan information. The AP utilization information may comprise information indicative of each time period of a plurality of time periods each network device uses the internet, and the AP scan information may comprise information indicative of each network device that can detect a radio signal of another network device of the plurality of network devices. The interference data is indicative of interferences caused by a network device detecting a radio signal of another network device of the plurality of network devices and the percentage of time each network device uses the internet during at least one time period of a plurality of time periods. At step 706, at least two network devices of the plurality of network devices may be caused to use the same frequency during different time periods based on determining that each network device of the at least two network devices uses the same frequency, or the internet a high percentage of time, during the different time periods regardless of whether each network device of the at least two network devices may be able to detect the other network device's signal.

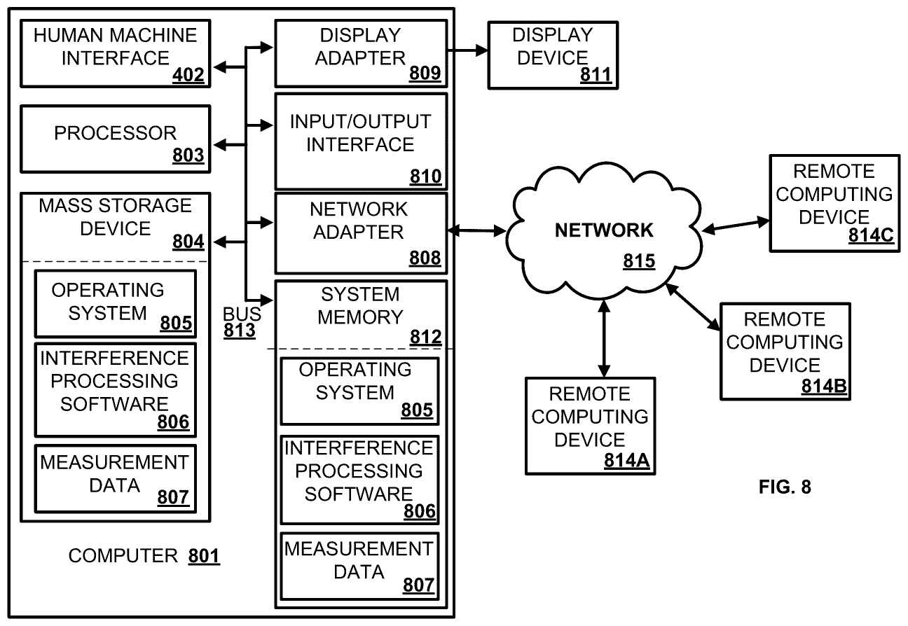

FIG. 8 is a block diagram illustrating an example computing device. The methods and systems can be implemented on a computer 801 as illustrated in FIG. 8 and described below. By way of example, user device 102 and computing device 104 of FIG. 1 can be a computer 801 as illustrated in FIG. 8. Similarly, the methods and systems disclosed can utilize one or more computers to perform one or more functions in one or more locations. FIG. 8 is a block diagram illustrating an exemplary operating environment 800 for performing the disclosed methods. This exemplary operating environment 800 is only an example of an operating environment and is not intended to suggest any limitation as to the scope of use or functionality of operating environment architecture. Neither should the operating environment 800 be interpreted as having any dependency or requirement relating to any one or combination of components illustrated in the exemplary operating environment 800.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 801. The computer 801 can comprise one or more components, such as one or more processors 803, a system memory 812, and a bus 813 that couples various components of the computer 801 including the one or more processors 803 to the system memory 812. In the case of multiple processors 803, the system can utilize parallel computing.

The bus 813 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 813, and all buses specified in this description can also be implemented over a wired or wireless network connection and one or more of the components of the computer 801, such as the one or more processors 803, a mass storage device 804, an operating system 805, interference processing software 806, measurement data 807, a network adapter 808, system memory 812, an Input/Output Interface 810, a display adapter 809, a display device 811, and a human machine interface 802, can be contained within one or more remote computing devices 814A-814C at physically separate locations, connected through buses of this form, in effect implementing a fully distributed system.

The computer 801 typically comprises a variety of computer readable media. Exemplary readable media can be any available media that is accessible by the computer 801 and comprises, for example and not meant to be limiting, both volatile and non-volatile media, removable and non-removable media. The system memory 812 can comprise computer readable media in the form of volatile memory, such as random access memory (RAM), and/or non-volatile memory, such as read only memory (ROM). The system memory 812 typically can comprise data such as measurement data 807 and/or program modules such as operating system 805 and interference processing software 806 that are accessible to and/or are operated on by the one or more processors 803.

The computer 801 can also comprise other removable/non-removable, volatile/non-volatile computer storage media. By way of example, the computer 801 can comprise a mass storage device 804 which can offer non-volatile storage of computer code, computer readable instructions, data structures, program modules, and other data for the computer 801. For example, a mass storage device 804 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 804, including by way of example, an operating system 805 and interference processing software 806. One or more of the operating system 805 and interference processing software 806 (or some combination thereof) can comprise elements of the programming and the interference processing software 806. Measurement data 807 can also be stored on the mass storage device 804. Measurement data 807 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 815.

The user can enter commands and information into the computer 601 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 803 via a human machine interface 802 that is coupled to the bus 813, but can be connected by other interface and bus structures, such as a parallel port, game port, an IEEE 1394 Port (also known as a Firewire port), a serial port, network adapter 808, and/or a universal serial bus (USB).

A display device 811 can also be connected to the bus 813 via an interface, such as a display adapter 809. It is contemplated that the computer 801 can have more than one display adapter 809 and the computer 801 can have more than one display device 811. For example, a display device 811 can be a monitor, an LCD (Liquid Crystal Display), light emitting diode (LED) display, television, smart lens, smart glass, and/or a projector. In addition to the display device 811, other output peripheral devices can comprise components such as speakers (not shown) and a printer (not shown) which can be connected to the computer 801 via Input/Output Interface 810. Any step and/or result of the methods can be output in any form to an output device. Such output can be any form of visual representation, including, but not limited to, textual, graphical, animation, audio, tactile, and the like. The display 811 and computer 801 can be part of one device, or separate devices.

The computer 801 can operate in a networked environment using logical connections to one or more remote computing devices 814A, 814B, and 814C. By way of example, a remote computing device 814A-814C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 801 and a remote computing device 814A-814C can be made via a network 815, such as a local area network (LAN) and/or a general wide area network (WAN). Such network connections can be through a network adapter 808. A network adapter 808 can be implemented in both wired and wireless environments. Such networking environments are conventional and commonplace in dwellings, offices, enterprise-wide computer networks, intranets, and the Internet.

For purposes of illustration, application programs and other executable program components such as the operating system 805 are illustrated herein as discrete blocks, although it is recognized that such programs and components can reside at various times in different storage components of the computer 801, and are executed by the one or more processors 803 of the computer 801. An implementation of interference processing software 806 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
receiving, by a computing device, measurement data associated with a plurality of access points (APs);
determining, based on the received measurement data, data indicative of AP utilization information and AP scan information; and
causing, based on the data, an allocation of a plurality of frequencies used by each AP of the plurality of APs.

2. The method of claim 1, wherein the measurement data is received at predetermined intervals.

3. The method of claim 1, wherein the measurement data is received over a predetermined period of time.

4. The method of claim 1, wherein the measurement data comprises one or more of a percentage of time each AP uses each frequency of the plurality of frequencies, each time period of a plurality of time periods each AP uses each frequency, an amount of time each AP uses each frequency, a signal strength associated with a radio signal of each AP, or information indicative of each AP that can detect a radio signal of another AP of the plurality of APs.

5. The method of claim 1, wherein the AP utilization information comprises a percentage of time each frequency of the plurality of frequencies is used by each AP, and wherein the AP scan information comprises information indicative of each AP that can detect a radio signal of another AP of the plurality of APs.

6. The method of claim 1, wherein causing, based on the data, the allocation of the plurality of frequencies used by each AP comprises causing, based on a comparison of a percentage of time each frequency of the plurality of frequencies is used by each AP and information indicative of each AP that can detect a radio signal of another AP of the plurality of APs.

7. The method of claim 1, wherein causing, based on the data, the allocation of the plurality of frequencies used by each AP of the plurality of APs comprises:
determining a Gradient Descent model associated with the data and a soft allocation of a plurality of frequencies used by the plurality of APs;
determining, based on the Gradient Descent model, an interference value associated with the plurality of APs; and
causing, based on the interference value, the allocation of the plurality of frequencies used by each AP of the plurality of APs.

8. The method of claim 7, wherein the interference value associated with the plurality of APs comprises one or more of a total interference value associated with the plurality of APs or a maximum interference value associated with the plurality of APs.

9. The method of claim 1, wherein causing, based on the data, the allocation of the plurality of frequencies used by each AP of the plurality of APs comprises:
determining one or more input parameters for a network;
determining, based on the one or more input parameters for the network, a soft allocation of a plurality of frequencies used by the plurality of APs;
determining, based on the data and the soft allocation of the plurality of frequencies used by the plurality of APs, an interference value associated with the plurality of APs; and
determining, based on the interference value, the allocation of the plurality of frequencies used by each AP of the plurality of APs.

10. The method of claim 9, wherein the one or more input parameters comprise one or more dummy scalar parameters.

11. The method of claim 9, wherein determining the one or more input parameters for the network comprises using a Gradient Descent model to iteratively update the one or more input parameters until the interference value associated with the plurality of APs comprises a target value.

12. The method of claim 9, wherein the interference value associated with the plurality of APs comprises one or more of a total interference value associated with the plurality of APs or a maximum interference value associated with the plurality of APs.

13. The method of claim 9, wherein the network comprises a neural network.

14. The method of claim 1, wherein causing the allocation of the plurality of frequencies used by each AP of the plurality of APs comprises causing each AP to use a frequency of the plurality of frequencies.

15. A method comprising:
receiving, by a computing device, measurement data associated with a plurality of access points (APs);
determining, based on the received measurement data, data indicative of AP utilization information and AP scan information; and
causing, based on the data, at least two APs of the plurality of APs to use a frequency of the plurality of frequencies.

16. The method of claim 15, wherein the measurement data is received at predetermined intervals.

17. The method of claim 15, wherein the measurement data is received over a predetermined period of time.

18. The method of claim 15, wherein the measurement data comprises one or more of a percentage of time each AP of the plurality of APs uses each frequency of the plurality of frequencies, each time period of a plurality of time periods each AP of the plurality of APs uses each frequency of the plurality of frequencies, an amount of time each AP of the plurality of APs uses each frequency of the plurality of frequencies, a signal strength associated with a radio signal of each AP of the plurality of APs, or information indicative of each AP of the plurality of APs that can detect a radio signal of another AP of the plurality of APs.

19. The method of claim 15, wherein the AP utilization information comprises information indicative of a percentage of time each frequency of the plurality of frequencies is used by each AP of the plurality of APs, and the AP scan information comprises information indicative of each AP of the plurality of APs that cannot detect a radio signal of another AP of the plurality of APs.

20. The method of claim 15, wherein causing, based on the data, the at least two APs of the plurality of APs to use a frequency of the plurality of frequencies comprises:
determining, based on the data, an AP of the at least two APs cannot detect a radio signal of another AP of the at least two APs; and
causing, based on the AP of the at least two APs not detecting the radio signal of another AP of the at least two APs, the at least two APs of the plurality of APs to use the frequency of the plurality of frequencies.

21. A method comprising:
receiving, by a computing device, measurement data associated with a plurality of access points (APs);
determining, based on the received measurement data, data indicative of AP utilization information and AP scan information; and
causing, based on the data, each AP of the plurality of APs to use a frequency of a plurality of frequencies for at least one time period of a plurality of time periods.

22. The method of claim 21, wherein the measurement data is received at predetermined intervals.

23. The method of claim 21, wherein the measurement data is received over a predetermined period of time.

24. The method of claim 21, wherein the measurement data comprises one or more of a percentage of time each AP uses each frequency of the plurality of frequencies, each time period of a plurality of time periods each AP uses each frequency, an amount of time each AP uses each frequency, a signal strength associated with a radio signal of each AP, or information indicative of each AP that can detect a radio signal of another AP of the plurality of APs.

25. The method of claim 21, wherein the AP utilization information comprises information indicative of each time period of a plurality of time periods each AP uses the internet, and wherein the AP scan information comprises information indicative of each AP that can detect a radio signal of another AP of the plurality of APs.

26. The method of claim 21, wherein causing, based on the data, each AP to use a frequency of the plurality of frequencies for at least one time period of the plurality of time periods comprises causing, based on the data, each AP to use a frequency of the plurality of frequencies for at least one time period of the plurality of time periods that is not used by another AP of the plurality of APs during the at least one time period.
